(19) United States
(12) Patent Application Publication
(10) Pub. No.: US 2016/0056724 A1
(43) Pub. Date: Feb. 25, 2016

(54) Switching Power Supplies And Methods Of Operating Switching Power Supplies

(71) Applicant: Texas Instruments Incorporated, Dallas, TX (US)

(72) Inventors: Richard L. Valley, Nashua, NH (US); Ulrich B. Goerke, Dover, NH (US)

(21) Appl. No.: 14/465,586

(22) Filed: Aug. 21, 2014

(51) Int. Cl. H02M 3/335; H02M 1/08

(52) U.S. Cl. CPC H02M 3/33507; H02M 1/08; H02M 2001/0032

(57) ABSTRACT

A switching power supply includes a transformer having a primary side and a secondary side. The primary side is coupled to a switch for controlling current flow through the primary side and the secondary side generates an output voltage. A controller controls switching of the switch to generate a first power level on the secondary side of the transformer when the power supply is in a stand-by mode and a second power level when the power supply is in an active mode. A monitor samples the output voltage, generates a reference voltage, and generates a wake up signal in response the output voltage being less than the reference voltage. The controller controls the switch in response to the wake up signal to generate the first power level.

### BACKGROUND

Primary side regulated power supplies control the current in the primary side of a multi-winding inductor or transformer to regulate the power Output on the secondary side of the transformer. Flyback power supplies with primary side regulation (PSR) are a type of isolated power supply and are used in many AC to DC applications. For example, many wall chargers use PSR flyback power supplies to charge electronic devices such as cell phones, smart phones and tablet computers. Flyback power supplies control the current through the primary side of a transformer to control the output power. In some embodiments, a controller in a flyback power supply opens and closes a switch that is coupled in series with the primary side of the transformer, wherein the switching frequency is proportional to the output power on the secondary side of the transformer. High frequency switching is used for higher power applications, such as charging applications. Low frequency switching is used when the flyback power supply is in a stand-by mode or where little power is required to be supplied, such as when no devices are being charged by the flyback power supply. In other embodiments, different methods are used to change the output power of the flyback power supply.

In order to achieve very low output and input power during periods when there is no load coupled to the output or the load is drawing very little current, peak current in the primary side of the transformer is reduced. In some embodiments, this is achieved by lowering the switching frequency of the switch that controls the current through the primary side of the transformer. When the power supply is operating in these light or zero load conditions, the power supply is sometimes referred to as operating in a stand-by, sleep, or no-load mode. For example, the switching frequency may be as low as 25 Hz when the power supply is in the stand-by mode. When a device is connected to the output of the power supply, the device draws current and decreases the output voltage. If a device is connected to the power supply between switching states, when the power supply is in stand-by mode, the power supply may not be able to commence the higher frequency switching before the output voltage drops very low. In some situations, the output voltage drops low enough to adversely affect the device that is connected to the power supply.

### BRIEF DESCRIPTION OF THE DRAWINGS

FIG. 1 is a schematic illustration of an embodiment of a primary side regulated power supply.

FIG. 2 is a block diagram of an embodiment of the monitor of FIG. 1.

FIG. 3 is a flow chart describing the operation of the power supply of FIG. 1.

### DETAILED DESCRIPTION

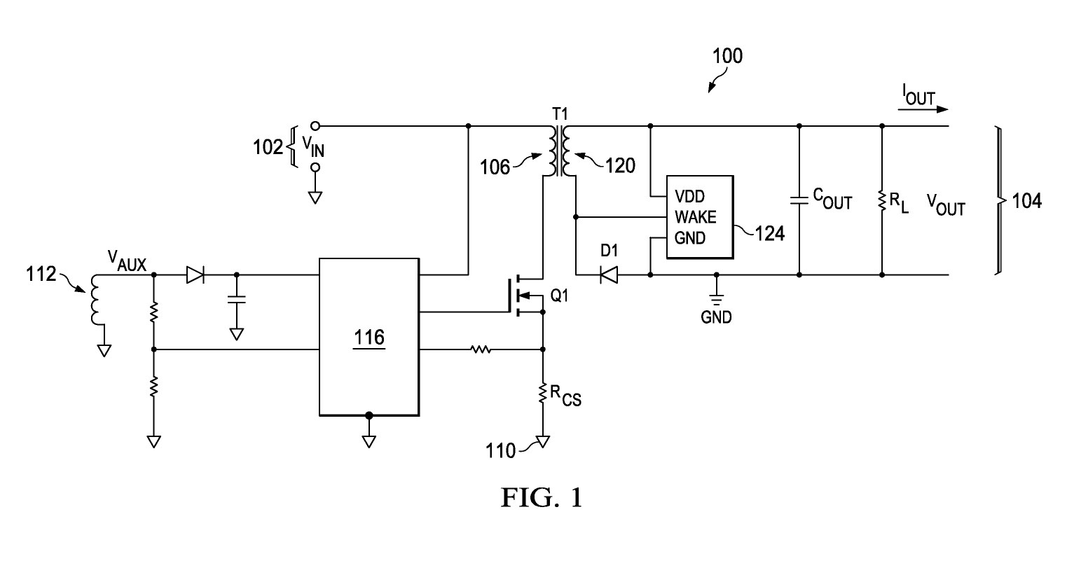

FIG. 1 shows a schematic illustration of an embodiment of a switching power supply, such as a primary side regulated power supply 100. The power supply 100 used in the examples herein is a flyback power supply, which is sometimes referred to as a flyback converter. The devices and methods described herein may be used in other power supplies, including other primary side regulated power supplies. The power supply 100 has an input 102 that is connectable to an input voltage V_{IN} and an output 104 that outputs an output voltage V_{OUT}. In the embodiment of FIG. 1, the input voltage V_{IN} is a DC voltage. In other embodiments, the input voltage V_{IN} is an AC voltage that is rectified. For example, in some embodiments, the input 102 is coupled (e.g. connected) to a rectifier (not shown) followed by an energy storage capacitor (not shown) that rectifies and/or filters the AC input voltage so that the input voltage V_{IN} of the power supply 100 approximates a DC input voltage.

The input 102 is coupled to the primary side 106 of a transformer T1. In some embodiments, an inductor is used in place of the transformer T1. The primary side 106 of the transformer T1 is coupled to a ground 110 by way of a switch Q1 and a current sensing resistor R_{CS}. In the embodiment of FIG. 1, the switch Q1 is a field effect transistor (FET), however, other devices that control current flow may be used in place of the FET. The current sensing resistor R_{CS} is a low ohm resistor that has little effect on the current flowing through the primary side 106 of the transformer T1. The resistor R_{CS} is coupled to a controller 116 that measures or reacts to the voltage drop across the resistor R_{CS} to control or calculate the current flow through the primary side 106 of the transformer T1. The primary side 106 of the transformer has an auxiliary winding 112 that, for purposes described herein, transmits signals from one side of the transformer T1 to the other side as described in greater detail below. The controller 116 monitors voltages and/or currents in the power supply 100 and controls the switching of the switch Q1.

The output 104 of the power supply 100 is coupled to the secondary side 120 of the transformer T1. In the embodiment of FIG. 1, the output 104 is coupled to a load resistor R_{L} and an output capacitor C_{OUT} that filter AC components from the output voltage V_{OUT}. In some embodiments, a load resistor R_{L} is not coupled to the output 104. As described above, the auxiliary winding 112 enables communications between the primary side 106 and the secondary side 120 of the transformer T1. A monitor 124 monitors the output voltage V_{OUT} to determine if a load (not shown) has been coupled to the output 104. The load may be any electronic device, such as a device that is being charged by the power supply 100. In some embodiments, the monitor 124 monitors for an increase in the power drawn by a device coupled to the output 104. For example, the monitor 124 can determine if the coupled load starts drawing additional current. Higher power is output by the power supply 100 when a load is coupled to the output 104 than when no device is coupled to the output 104. The power that is output by the power supply 100 when it is in a stand-by mode or a coupled load that is drawing little power is referred to as the first power level. The power that is able to be output by the power supply 100 when a load is connected or when a coupled load draws additional power is referred to as the second power level.

In the embodiment of FIG. 1, the monitor 124 has nodes referred to as “wake”, “VDD”, and ground. The VDD node is coupled to the output 104 and has the same potential as the output voltage V_{OUT}. The wake node is coupled to the secondary side 120 of the transformer 120 and, in the embodiment of FIG. 1, serves as both an input and an output. As an input, the wake node monitors voltage pulses on the secondary side 120 of the transformer T1 resulting from switching of the switch Q1, wherein the pulses are due to power cycles on the primary side 106 of the transformer T1. In some embodiments, detection of these pulses causes the monitor 124 to sample the output voltage V_{OUT} as described in greater detail below. In some embodiments, when the voltage on the wake node falls below a predetermined voltage, meaning that a pulse has not been detected, the monitor 124 samples the output voltage V_{OUT}. In some embodiments, when the voltage falls below 50 mV for a period greater than 500 ns, the monitor 124 samples the output voltage V_{OUT} irrespective of whether a pulse has been detected. When the voltage on the wake node subsequently rises above a predetermined level, such as above 50 mV, a pulse, such as a 2.6 μs pulse, is generated to trigger a new sample of the output voltage V_{OUT}. The monitor circuit 124 may use different times during the charging cycle to sample the output voltage V_{OUT}. In some embodiments, the sampling occurs when the voltage on the wake node rises above a predetermined voltage, such as zero or 50 mV, which is when an output rectifier (D1) stops conducting. When the rectifier stops conducting, current is not flowing from the transformer T1 into the output 104. During this period, voltage perturbations induced by the output current of the transformer T1 are avoided when sampling the output voltage V_{OUT}.

If the output voltage V_{OUT} droops to a predetermined value relative to the last sampled output voltage, the wake node is driven as an output via the auxiliary winding 112. In some embodiments, the wake node is driven as an output when the output voltage V_{OUT} droops to 97% of the last sampled output voltage. When the wake node is an output, the monitor 124 injects current into the secondary side 120 of the transformer T1 until a power cycle from the primary side 106 is detected. More specifically, when the output voltage V_{OUT} droops, a load has been coupled to the output 104 or increased power is being drawn, so the monitor 124 sends a signal via the transformer T1 to the controller 116 indicating the second power level is needed to drive the device coupled to the output 104. In some embodiments, the wake node injects current into the transformer T1 for 1 μs at a 33 kHz rate until the power cycle is detected.

The diode D1 prevents the current generated by the monitor 124 from interfering with the output voltage V_{OUT}. In addition, the wake signal occurs when the diode D1 is reverse biased. The diode D1 also serves other purposes, such as allowing demagnetization current from the transformer T1 to flow into the output circuit following the turn-off of the FET Q1 and then to isolate the secondary side 120 during the remainder of the switching cycle. The diode D1 can be replaced by other devices that perform similar functions.

Having described the basic components of the power supply 100, its operation will now he summarily described followed by a detailed description of the monitor 124. The power supply 100 generates the output voltage V_{OUT} using the input voltage V_{IN}. The input 102 is coupled to the primary side 106 of the transformer T1 wherein current flow through the transformer T1 is controlled by the switch Q1. In the embodiment of FIG. 1 wherein the switch Q1 is a FET, the controller 116 is coupled to the gate of the FET and controls the current flow by way of the gate voltage. In some embodiments, pulse width modulated signals are used to control the gate voltage, so that longer duty cycles and/or higher frequencies result in greater current flow through the primary side 106 of the transformer T1. The power supply 100 may operate the transformer T1 in a discontinuous current mode when outputting the first power level and a continuous current mode when outputting the second power level. When the transformer T1 operates in continuous current mode, the output power, which is related to the output voltage V_{OUT} for a given load level, is controlled by varying the operating current level of the transformer T1. In discontinuous current mode, or at the boundary of continuous current mode and discontinuous current mode, referred to as the transition mode, the output power is controlled by varying one or both of the current level of the transformer T1 or the switching frequency of the FET Q1. The peak current flowing through the primary side 106 of the transformer T1 can be changed to switch between the first and second power levels.

The current flow through the primary side 106 of the transformer T1 determines the output voltage V_{OUT} and the power that the power supply 100 can output. When a load is coupled to the output 104 or additional power is drawn, the controller 116 causes the current flow through the primary side 106 of the transformer T1 to increase enough to supply the second power level to the device coupled to the output 104. When no load is coupled to the output 104 or very little power is drawn, the power supply 100 enters a stand-by mode where very little current flows through the primary side 106 of the transformer T1 and very little power is drawn by the power supply 100. In order to reduce the power drawn by the power supply 100, the switching rate of the switch Q1 is typically reduced. In some embodiments, the switching rate is lowered to low frequencies, such as 25 Hz.

The monitor 124 monitors the output voltage V_{OUT}. When a load is coupled to the output 104, the output voltage V_{OUT} droops. The drooping is detected by the monitor 124, which generates a signal by way of the wake node indicating that a load has been coupled to the output 104. The signal is sometimes referred to as a wake-up signal. The monitor 124 generates the signal by inducing a current on the auxiliary winding 112, which is detected by the controller 116. The controller 116 then brings the power supply 100 out of the stand-by mode and into another mode, sometimes referred to as an active mode, wherein the second power level is generated at the output 104. The process of coming out of the stand-by mode is sometimes referred to as waking the power supply 100. As described above, the second power level may be achieved by increasing the peak current flow through the primary side 106 of the transformer T1, increasing the switching frequency, or both.

In some conventional primary side regulated power supplies the minimum switching frequency is limited to a rate that is high enough level so that the potential droop in the output voltage between switching cycles is held to an acceptable level and the monitor 124 is not required. This minimum frequency comes at the expense of higher input power when the power supplies are in stand-by modes. In some other embodiments where standby power is to be further reduced, the switching frequency can be lower, which causes the potential droop to be much worse.

In some of these conventional power supplies a conventional monitor, that monitors the output voltage dropping to a specific voltage before generating a wake-up signal, is used to transition the power supply out of the stand-by mode. As an example, the power supply may generate five volts at its output. When a load is coupled to the output, the output voltage may droop to a detection threshold of 4.8 volts. In some embodiments the conventional monitor generates the wake-up signal at the next switching cycle after detecting the 4.8 volts. A controller detects the wake-up signal and increases the power available at the output. One of the problems with these conventional monitors is that the detection threshold can interfere with the normal regulation tolerance of the output voltage. For example a 5 volt output may only be able to be controlled to levels of 4.75 V to 5.25 V due to normal component parameter tolerances or operating condition variance. In such an embodiment, a specific 4.8 V droop threshold would interfere with normal regulation of these power supplies. Another disadvantage is that the monitor only monitors for droop on a specific nominal voltage. Accordingly, each monitor will only work with a single voltage output, meaning that a monitor for a power supply having five volt output will not work for a power supply having a 28.0 volt output. Furthermore, if a tight droop tolerance needs to be maintained, i.e. something under 5% for the 5 V case described, a programmable, but non-varying droop threshold is not adequate.

The power supply 100 of FIG. 1 overcomes the above-described problems with conventional power supplies. The monitor 124 is coupled to the output 104 of the power supply 100 and monitors the output 104 for a load transient by monitoring the output voltage V_{OUT}. When a voltage droop is detected relative to a previously sampled output voltage, a wake-up signal is generated at the wake node of the monitor 124 and transmitted to the primary side 106 by way of the auxiliary winding 112. The controller 116 detects this signal and immediately begins switching the switch Q1 in a manner that increases the power output at the secondary side 120 of the transformer T1.

FIG. 2 is a block diagram of an embodiment of the monitor 124. The monitor 124 includes a sample and hold circuit 200 having an input 202 that is coupled to the output 104 of the power supply 100, FIG. 1. The sample and hold circuit 200 samples the output voltage V_{OUT} and holds the voltage at an output 204. The monitor circuit 124 also includes a reference generator 206 having an input 208 that is coupled to the output 204 of the sample and hold circuit 200. The reference generator 206 has an output 210 wherein the voltage at the output 210 is proportional to the voltage at the input 208. The proportional voltage at the output 210 is sometimes referred to as the scaled voltage of the output voltage V_{OUT} or the reference voltage. In some embodiments, the voltage at the output 210 is approximately 97% of the voltage at the input 208. In other embodiments, the scaling between the voltage at the input 208 and the voltage at the output 210 has values other than 97%.

The output 210 of the reference generator 206 is coupled to a comparator 220. In the embodiment of FIG. 2, the output 104 of the power supply 100 is coupled to an inverting input of the comparator 220 and the output 210 of the reference generator 206 is coupled to the non-inverting input of the comparator 220. The comparator 220 has an output 222, wherein the voltage at the output 222 changes state when the difference between the inverting input and the non-inverting input exceeds a predetermined value. In some embodiments, the output 222 has a first voltage when the voltage at the inverting input is greater than the voltage at the non-inverting input and a second voltage when the voltage at the inverting input is less than the voltage at the non-inverting input.

In the embodiment of FIG. 2, the output 222 of the comparator 220 is coupled to a trigger generator 230 that generates the wake signal in response to a signal or change in voltage from the comparator 220. In the embodiment of FIG. 2, the wake node outputs a current pulse that is detected on the auxiliary winding 112, FIG. 1, by the controller 116. In some embodiments, the trigger generator 230 is a one shot device that generates a pulse, such as the above-described current pulse, in response to the signal from the comparator 220. The current pulse indicates that a load has been connected to the power supply 100, FIG. 1, and enables the power supply 100 to output the second level of power. In some embodiments, the second level of power is the result of a change in the load coupled to the output 104. For example, a device coupled to the output 104 may need to draw more power, so the second level of power is provided to the device.

The operation of the monitor 124 will now be described. The sample and hold circuit 200 samples the output voltage V_{OUT} and holds it at the output 204. In some embodiments, the sampling frequency of the sample and hold circuit is the same as the switching frequency of the switch Q1, FIG. 1. In other embodiments, the sample rate of the sample and hold circuit 200 is greater than or less than the switching frequency of the switch Q1. The reference generator 206 scales the sampled output voltage V_{OUT} at the output 204 of the sample and hold circuit 200 and outputs the scaled voltage at the output 210. In some embodiments, the scaled voltage is 97% of the sampled output voltage V_{OUT} and in some embodiments the scaling is achieved using a resistor network (not shown). When the output voltage V_{OUT} is greater than the scaled voltage output by the reference generator 206, there is no load coupled to the output 104, FIG. 1, of the power supply 100. The greater output voltage V_{OUT} may also mean that low power is being drawn by a device coupled to the output 104. In some embodiments, the wake node generates a signal indicating that the power supply 100 is to remain in a stand-by mode when no load is coupled to the output 104. In the stand-by mode, the power supply 100 outputs the first power level.

When the switch Q1 switches, a pulse is induced on the auxiliary winding 112, which is detected at the wake node. In some embodiments, the pulse is detected on the secondary winding 120 of the transformer T1. The output voltage V_{OUT} is set by the switching characteristics, such as the frequency, of the switch Q1. The sampled and scaled voltage is held at the output 210 of the reference generator 206, which is coupled to the inverting input of the comparator 220. The output voltage V_{OUT} is continually compared to the reference voltage output by the reference generator 206 using the comparator 220.

When an increased load is applied to the output 104 of the power supply 100, the output voltage V_{OUT} droops. However, the reference voltage at the output 210 of the reference generator 206 will not change until the next time that it is sampled because it is held by the sample and hold circuit 200. When the output voltage V_{OUT} droops to a predetermined value relative to the reference voltage, which in the embodiments described herein is 97% of the sampled Output voltage V_{OUT}, the voltage at the non-inverting input of the comparator 220 becomes less than the voltage at the inverting input. When this occurs, the voltage at the output 222 of the comparator 220 changes. The voltage change causes the trigger generator 230 to generate a signal that induces a current in the auxiliary winding 112 to indicate that the power supply 100 needs to output enough power to drive the coupled load. In the embodiments described above, this power is referred to as the second power level.

The monitor 124 generates the wake up signal based on the output voltage V_{OUT} falling below the voltage output by the reference generator 206 and not based on the output voltage V_{OUT} falling below a predetermined fixed voltage. Because of the use of the reference voltage, the monitor 124 may be used with virtually any power supply regardless of the output voltage. For example, if the power supply 100 is outputting five volts at the first power level, the monitor 124 will generate a wake up signal when the output voltage V_{OUT} droops to 4.85 volts between samples of the output voltage V_{OUT}. If the power supply 100 is outputting twenty volts as the first power level, the monitor 124 will generate the wake up signal when the output voltage V_{OUT} droops to 19.4 volts between samples of the output voltage V_{OUT}.

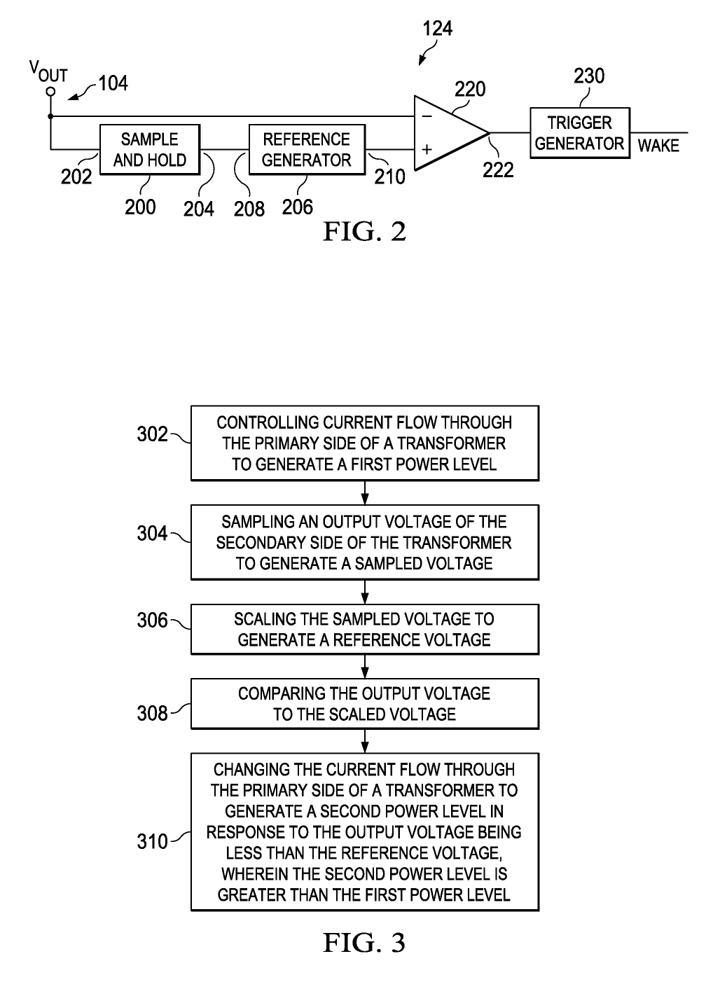

An embodiment of the operation of the power supply 100 is described by the flowchart of FIG. 3. At step 302, current flow through the power supply 100 is controlled to generate a first power level. At step 304, the output voltage V_{OUT} at the secondary side 120 of the transformer T1 is sampled to generate a sampled voltage. The sampled voltage is scaled at step 306 to generate a reference voltage. At step 308, the current flow through the primary side of a transformer is changed to generate a second power level in response to the output voltage being less than the reference voltage, wherein the second power level is greater than the first power level.

In some embodiments, the sample and hold circuit 200 or other circuit samples several output voltages and compares a selection of them to the reference voltage. For example, an average of several sampled output voltages may he used to generate the reference voltage.

Although illustrative embodiments have been shown and described by way of example, a wide range of alternative embodiments is possible within the scope of the foregoing disclosure. The applicant intends that the appended claims be broadly construed to cover such alternative embodiments, except as limited by the prior art.

What is claimed is:

1. A switching power supply comprising:
a transformer having a primary side and a secondary side, the primary side being coupled to a switch for controlling current flow through the primary side, the secondary side generating an output voltage;
a controller for controlling switching of the switch to generate a first power level on the secondary side of the transformer when the power supply is in a stand-by mode and a second power level when the power supply is in an active mode;
a sample and hold circuit for sampling the output voltage and generating a sampled voltage;
a reference generator for generating a reference voltage that is a percentage of the sampled voltage; and
a comparator for comparing the reference voltage to the output voltage, wherein the comparator generates a wake up signal in response the output voltage being less than the reference voltage; and
wherein the controller controls the switch in response to the wake up signal to generate the first power level.

2. The power supply of claim 1, wherein the controller switches the switch and wherein the sample and hold circuit samples the output voltage at a rate approximately equal to the rate at which the controller switches the switch.

3. The power supply of claim 1, wherein the reference voltage is approximately 97 percent of the sampled voltage.

4. The power supply of claim 1, wherein the transformer further comprises an auxiliary winding coupled to the controller, and wherein the wake up signal is output to the auxiliary winding.

5. The power supply of claim 1, wherein the wake up signal induces a current in the transformer and wherein the current is detected by the controller.

6. The power supply of claim 1, wherein the controller switches the switch at a first rate to generate the first power level and wherein the controller switches the switch at a second rate to generate the second power level.

7. The power supply of claim 1, wherein the controller switches the switch at a first rate to generate the first power level, wherein the controller switches the switch at a second rate to generate the second power level, wherein the first rate is slower than the second rate.

8. The power supply of claim 1, wherein the controller switches the switch to generate a first peak current level for generating the first power level, wherein the controller switches the switch to generate a second peak current level for generating the second power level, wherein the first peak current is less than the second peak current.

9. The power supply of claim 1, wherein the controller switches the switch to generate a discontinuous current flow through the primary side of the transformer for generating the first power level and wherein the controller switches the switch to generate a continuous current flow through the primary side of the transformer for generating the second power level.

10. The power supply of claim 1, wherein the primary side regulated power supply is a flyback power supply.

11. The power supply of claim 1, wherein the sample and hold circuit samples a plurality of voltages and holds a voltage in response to the plurality of voltages.

12. The power supply of claim 1, wherein the sample and hold circuit samples a plurality of voltages and holds an average of the plurality of voltages.

13. A method for operating a switching power supply, the method comprising:
controlling current flow through the primary side of a transformer to generate a first power level;
sampling an output voltage of the secondary side of the transformer to generate a sampled voltage;
scaling the sampled voltage to generate a reference voltage;
comparing the output voltage to the reference voltage; and
changing the current flow through the primary side of a transformer to generate a second power level in response to the output voltage being less than the reference voltage, wherein the second power level is greater than the first power level.

14. The method of claim 13, wherein the switch is switched at a frequency, and wherein the output voltage is sampled at the switching rate of the switch.

15. The method of claim 14, wherein the sampling of the output voltage occurs at the end of a switching cycle.

16. The method of claim 13, wherein changing the current flow through the primary side of the transformer to generate the second power level comprises increasing the peak current flow through the primary side of the transformer.

17. The method of claim 13, wherein changing the current flow through the primary side of the transformer to generate the second power level commences by inducing a current in an auxiliary winding of the transformer.

18. The method of claim 13, wherein the sampling includes sampling a plurality of output voltages, and wherein the sampled voltage is based on the plurality of output voltages.

19. The method of claim 18, wherein the sampled voltage is the average of the output voltages.

20. A method for operating a primary side regulated power supply, the method comprising:
switching current flow through the primary side of a transformer to generate a first power level when the power supply is in a stand-by mode;
sampling an output voltage coupled to the secondary side of the transformer to generate a sampled voltage;
scaling the sampled voltage to generate a reference voltage;
comparing the output voltage to the reference voltage; and
changing the current flow through the primary side of a transformer to generate a second power level in response to the output voltage being less than the reference voltage, wherein the second power level is greater than the first power level;
wherein changing the current flow includes increasing the frequency of the current flow through the primary side of the transformer.
